(19) United States
(12) Patent Application Publication
(10) Pub. No.: US 2015/0342714 A1
(43) Pub. Date: Dec. 3, 2015

(54) Dispensing Container for Dental Compound

(71) Applicant: Transcodent GmbH & Co. KG, Kiel (DE)

(72) Inventor: Joachim Fritze, Preetz (DE)

(21) Appl. No.: 14/821,153

(22) Filed: Aug. 7, 2015

Related U.S. Application Data
(63) Continuation-in-part of application No. 13/767,079, filed on Feb. 14, 2013.

(30) Foreign Application Priority Data
Feb. 22, 2012 (DE) 10 2012 202 693.2

(51) Int. Cl. A61C 19/06; A61C 17/02; A61C 5/06

(52) U.S. Cl. CPC A61C 19/063; A61C 5/062; A61C 17/0202

(57) ABSTRACT

A dispensing system comprising a discharge tool in the form of a compule gun and a replaceable dispensing container in the form of a compule for dental compound. The dispensing container comprises a housing, on the inside of which a slide surface is formed that is intended for engagement with a plunger. The housing encloses an interior and is provided with an outlet channel. A portion of a needle is inserted into the outlet channel. A gap is present between the circumference of the needle and the outlet channel. An adhesive is introduced into the gap. A ram in the discharge tool engages the plunger. A method also produces a dispensing system of this kind.

### BACKGROUND

The invention relates to a discharge tool containing dispensing container for dental compound in the form of a compule, which is adapted for use together with a compule gun. The dispensing container comprises a housing, on the inside of which a slide surface is formed that is intended for engagement with a plunger. The housing encloses an interior and is provided with an outlet channel. The housing with outlet channel is designed as a one-piece injection-molded part. A portion of a needle is arranged in the outlet channel. A portion of a needle is arranged in the outlet channel. The invention also relates to a method for producing a dispensing container of this kind.

Discharge tools and dispensing containers of this kind are used in order to discharge dental compounds in a specific and metered manner. Before use, the state of the dispensing container is generally one in which the interior is filled with the dental compound and the plunger is inserted into the interior in order to close off the interior and separate the dental compound from the environment. The dispensing container is then connected to a discharge tool, such that a ram of the discharge tool can apply pressure to the plunger. Under the pressure exerted by the plunger, the dental compound moves right through the needle and emerges at the front end of the needle. The dental compound can be discharged at locations that are otherwise accessible only with difficulty.

In the production of the dispensing container, the needle is first manufactured as a separate part and is then connected to the housing of the dispensing container. When connecting the needle to the dispensing container, care must be taken that the connection is sufficiently firm to ensure that the connection does not come undone even when the dental compound in the container is subjected to pressure. Moreover, the connection must be tight, such that the dental compound can emerge only through the needle, not to the sides.

This can be achieved if, for example, the housing is produced as an injection-molded part and the needle is injected into the housing directly during the injection molding. An intimate connection that meets the above requirements is then formed between the material of the housing and the outer wall of the needle. However, a disadvantage is that an injection mold is needed that is exactly adapted to the housing and to the needle. If a needle with a greater diameter is to be connected to the housing, a completely new injection mold is needed.

### SUMMARY

A dispensing container in the form of a compule and discharge tool in the form of a compule gun for dental compound is produced in an adaptable and cost-effective manner.

A gap is present between the circumference of the needle and the outlet channel, and an adhesive is introduced into said gap.

Some terms will first be explained. The interior of the housing is intended to receive dental compound. The term housing does not mean that the interior is closed off all the way around. In addition to the outlet channel, a further opening is generally present which can be closed by a plunger and via which the dental compound can be subjected to pressure. The direction in which the needle protrudes from the outlet channel is designated as the front end, the opposite direction as the rear end. The term dental compound is not to be understood as a limitation in respect of the consistency of the material, For example, the dental compound can be liquid or pasty.

In order to connect the needle to the housing, a portion of the needle is inserted into the outlet channel of the housing. The adhesive in the gap remaining between the needle and the outlet channel produces a firm connection between the needle and the housing. This type of production is cost-effective and, when a suitable adhesive is used, leads to a very stable connection between the needle and the housing. The stability of the connection is desired on account of the fact that, when the dispensing container is being used, various forces such as tensile forces, pressing forces, bending forces and torques may act on the connection.

The gap can extend as an annular gap all the way around the needle portion. The diameter of the gap can be constant about the circumference. It is also possible for the width of the gap to vary about the circumference. For example, two portions of the gap can be separated from each other by a web that extends parallel to the needle. The web can bear on the outer surface of the needle, or a gap with a smaller diameter can be present between the web and the outer surface.

The housing is preferably designed such that an unambiguous position for the needle is defined in the longitudinal direction. For this purpose, a limit stop can be provided in the outlet channel, on which limit stop the needle bears when it has reached the correct position in the outlet channel. The limit stop can protrude inward from the wall of the outlet channel, such that the end face of the needle bears on the limit stop. By inserting the needle into the outlet channel as far as the limit stop, it is easy to find the correct position for the needle. The limit stop can be dimensioned in such a way that it is suitable for needles of different diameter.

If the gap extends about the entire circumference of the needle and along the entire length of the needle portion inserted into the outlet channel, the needle at first has play for movement in the lateral direction. It is only by the adhesive in the gap that the needle is fixed in its final position. It can be advantageous if the outlet channel is designed such that it provides a lateral guide for the needle, with the result that the orientation of the needle and its position in the lateral direction are unambiguously defined. For this purpose, a plurality of inwardly protruding webs can be present in the outlet channel, for example, and bear on the outer face of the needle.

The outlet channel can also have, as a lateral guide, a first channel portion in which the inner surface of the channel is adapted to the outer surface of the needle. In the first channel portion, for example, a planar contact can exist between the needle and the channel and extend about the entire circumference of the needle. The gap is in this case present primarily in a second channel portion.

The first channel portion is preferably arranged at the rear end of the outlet channel. The second channel portion adjoins the front of the first channel portion. The adhesive can then be introduced into the gap of the second channel portion from the front end of the outlet channel.

For filling the gap with adhesive, it is advantageous if the outlet channel narrows from the front end in the direction of the rear end, i.e. with the diameter of the gap decreasing in this direction. It is possible that the narrowing extends along the entire length of the outlet channel. However, the narrowing often comprises only one portion of the outlet channel. This can be the second channel portion, for example. In order to promote uniform distribution of the adhesive in the gap, depressions can be formed in the narrowing channel portion. The gap has a slightly greater diameter in the area of the depressions, such that the adhesive can penetrate more easily in the direction of the rear end of the outlet channel. The adhesive is preferably heat-polymerizing or auto-polymerizing, such that hardening is possible without the influence of light. In order to optimize the adhesion, the surface of the needle and/or the outlet channel can be pretreated. Sand-blasting or an etching process with a roughening effect may be considered for metallic surfaces, for example. The pre-treatment of plastic surfaces can involve thermal treatment, corona discharge or another oxidative pre-treatment.

It is possible that the narrowing extends substantially uniformly over the channel portion in question. Alternatively, the narrowing can be more pronounced at the front end of the outlet channel, such that the outlet channel has a widening mouth. The diameter of the gap is increased in the area of the widening mouth, such that the adhesive can be easily introduced.

The gap surrounding the needle can extend along the entire length of the needle portion inserted into the outlet channel. This has the result that the needle is at first not guided in a defined manner in the outlet channel and instead can be moved in the lateral direction. Before the adhesive can be introduced into the gap, suitable means have to ensure that the needle is correctly centered in the outlet channel. The needle has a defined position in the outlet channel only after the gap has been filled with the adhesive and the adhesive has hardened. The adhesives that are presently available are suitable for filling a gap and at the same time producing a very stable connection. This way of producing a connection has the advantage that one uniformly dimensioned outlet channel can be provided with needles of different diameter. For example, a relatively short needle with a large diameter can be used for dental compounds of high viscosity. A longer needle with a small diameter can be used in order to ensure that the dental compound is subjected to certain shearing forces as it passes through the needle. The dispensing container can thus be adapted for different purposes, without anything having to be changed on the actual housing or the outlet channel.

The housing with outlet channel is preferably a one-piece component, which can be inexpensively produced as an injection-molded part, for example. The housing is preferably dimensioned such that the quantity of the dental compound it receives is apportioned exactly for one use. Compared with dispensing containers that are able to receive several application units of the dental compound, the danger of infections is reduced, since no pathogens can be transferred from a first patient to a second patient. The ready-to-use dispensing container is filled with dental compound, and a plunger is inserted into the interior of the dispensing container so that the interior is closed. The dispensing container may be replaced for additional applications of dental compounds.

The needle generally has an elongate cylindrical shape, of which the external diameter can be between 0.5 mm and 2 mm, for example. A channel through which the dental compound can pass extends within the needle. The needle can be made of metal. Since no great forces are applied to the needle when connecting the latter to the housing, the needle can be made of soft-annealed steel or a comparable material. This has the advantage that the needle is bendable, i.e. can be bent over, without breaking or without the channel in the interior being closed. During use, the user can shape the needle in the manner that appears suitable. The length of the needle can be between 13 mm and 23 mm, for example, such that the needle can be inserted deep into the root canal of a tooth.

With fairly long needle lengths, for example of at least 15 mm, preferably of at least 20 mm, it is possible to heighten the shearing forces that act on the dental compound as it passes through the needle. In some dental compounds, shearing forces of this kind are desirable since the properties of the material are thereby influenced in a positive manner.

The needle can be provided with an outlet opening at its front face, such that the dental compound can be forwardly discharged. In addition or alternatively, the needle can have one or more outlet openings pointing in the lateral direction. This permits better filling of the lateral branches of the root canal.

A stable connection between the needle and the outlet channel is needed, since considerable forces may act on the needle in various situations. If a dental compound of high viscosity is forced through the needle, a strong force acts in the longitudinal direction of the needle. If the needle is bent in the lateral direction, strong bending forces are exerted. If the tip of the bent needle comes into abutment in the lateral direction during insertion into the tooth, a considerable torque can arise relative to the axis of the outlet channel. It has been shown that the adhesive connection provides sufficient stability in the face of all of these loads.

The housing of the dispensing container can have a discharge tip inside which the outlet channel extends. The outer face of the discharge tip can be designed such that a cap can be fitted onto the discharge tip and seal off the front end of the dispensing container. For example, the discharge tip can be round in cross section and narrow slightly toward the front. The dispensing container can also comprise a cap adapted to the discharge tip. The cap is preferably dimensioned such that it entirely encloses the needle. When the cap is fitted in place, the inner end face of the cap can bear on the front end of the needle in order to close an outlet opening of the needle. For secure closure, a projection, which can be hemispherical or conical for example, can be formed on the inner end face of the cap.

The inner wall of the cap can be bulged outward at the rear end. The cap can then be used to bend the needle when the bulge rests as an abutment on the bending point and a force acting in the lateral direction is applied to the front end of the cap. This ensures a uniform transfer of force to the needle and prevents damage to the needle. The risk of damage to the needle would be greater if, instead of the bulge, a sharp edge of the cap were to bear on the needle.

The cap should be designed such that, on the one hand, it can be easily fitted onto the discharge tip and, on the other hand, forms a secure seal with the discharge tip. For this purpose, a peripheral web can be formed on the inner wall of the cap and, when the cap is fitted in place, this web bears on the discharge tip about the entire circumference. It is possible to provide a plurality of such webs, which are arranged in succession in the axial direction.

To make the cap easier to handle, the outside of the cap can be provided with ribs, which preferably extend in the longitudinal direction. When the user wishes to fit the cap in place or remove it, the ribs provide a good purchase for his fingers.

The cap can be provided with a limit stop that comes to rest on the dispensing container as soon as the needle has been bent to the correct angle. The angle in question, between the front portion of the needle and the longitudinal direction of the container, is chosen such that the front end of the needle can be easily inserted into the cavity of a molar. For example, the angle can be between 25° and 60°, preferably between 30° and 45°. Such a limit stop makes it easier for the user to bend the needle to the desired angle.

An angle between the direction of the needle and the longitudinal axis of the dispensing container can also be obtained by virtue of the fact that the outlet channel encloses an angle with the longitudinal axis of the dispensing container. This angle is also preferably between 25° and 60°, preferably between 30° and 45°. In this case, the needle can extend rectilinearly in a continuation of the outlet channel but still be easily inserted into a cavity of a molar.

The needle can also be made of a material that has an elastic flexibility. The needle can then deform, during insertion into the root canal, such that it is able to follow bends in the root canal. It is then easier to discharge the dental compound as far as the apex of the root canal. The material of the needle can be a titanium alloy, preferably a p-titanium alloy. There are known to be 13-titanium alloys with a very low modulus of elasticity. In an alternative embodiment, the needle can be made of polypropylene, which is preferably colored and light-tight. This material too has the desired flexibility.

The invention further relates to a method for producing a dispensing container for dental compound. In the method, a needle and a housing are provided. On the inside of the housing, a slide surface is formed that is intended for engagement with a plunger. The housing encloses an interior and is provided with an outlet channel. A portion of the needle is inserted into the outlet channel, such that a gap remains between the circumference of the needle portion and the outlet channel. An adhesive is introduced into the gap. The method can be extended by further features, which are described with reference to the dispensing container.

### BRIEF DESCRIPTION OF THE DRAWINGS

The invention is described below on the basis of advantageous illustrative embodiments and with reference to the attached drawings, in which:

FIG. 1 shows a plan view of a dispensing container;

FIG. 2 shows a cross-sectional view of the dispensing container from FIG. 1;

FIG. 3 shows an enlarged view of the detail B of the housing from FIG. 2;

FIG. 4 shows the view from FIG. 3 in other embodiments;

FIG. 5 shows a dispensing container with a cap attached;

FIG. 6 shows an enlarged view of the cap from FIG. 5;

FIG. 7 shows the use of the cap for bending the needle;

FIG. 8 shows a further embodiment of a dispensing container; and

FIG. 9 shows a further embodiment of a dispensing container.

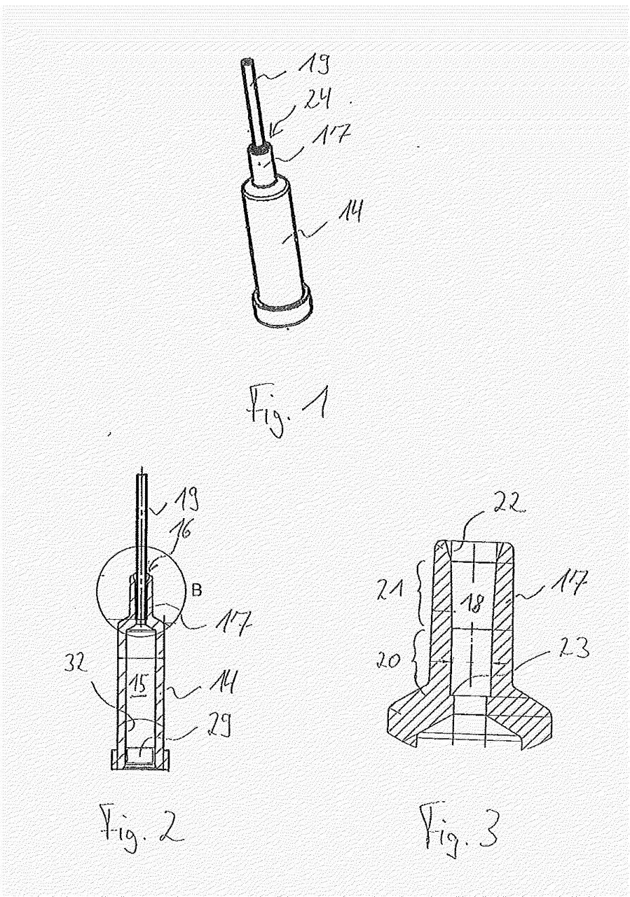

### DETAILED DESCRIPTION

A dispensing container comprises a housing 14, which encloses an interior 15. The interior 15 has a cylinder shape and is open at the rear end. At the front end, the housing 14 has a discharge tip 17 with an outlet channel 18 in the interior thereof. A needle 19 extends in a continuation of the discharge tip 17.

In the state when ready for use, the interior 15 of the dispensing container is filled with a dental compound, and the open end of the interior 15 is closed off by a plunger 29 as shown in FIG. 2. The plunger 29 is guided by the inner surface of the housing, which inner surface serves as a slide surface 32. When pressure is applied to the dental compound via the plunger 29, the dental compound moves through the needle 19 and emerges at the front end of the needle. Since the needle 19 is long and thin, the dental compound can be discharged with precision even at sites that are otherwise difficult to access. In order to apply pressure to the plunger 29, a discharge tool (not shown) is provided that has a ram for pressing the plunger 29 forward.

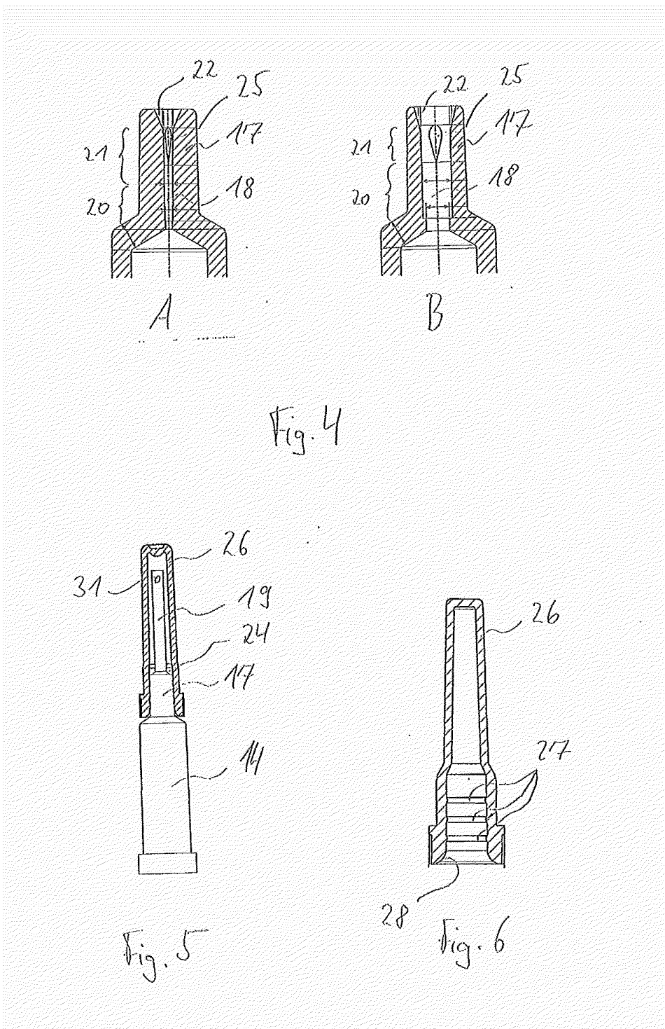

According to FIG. 3, the outlet channel 18 of the housing 14 comprises a first channel portion 20 and a second channel portion 21. In the first channel portion 20, the inner surface of the outlet channel 18 is adapted to the outer surface of the needle 19. The needle 19 can be inserted into the first channel portion 20 only when the needle 19 is centered and correctly aligned. At the rear end of the first channel portion 20, a limit stop 23 is formed against which the needle 19 abuts when it has reached its end position. In the first channel portion 20, a slight gap is at most present between the outer wall of the needle 19 and the inner wall of the outlet channel 18, such that the needle 19 can be inserted without great resistance.

In a second channel portion 21, the diameter of the outlet channel 18 narrows in the direction of the rear end. At the rear end, the diameter coincides with the first channel portion 20, such that there is a seamless transition between the channel portions 20, 21. The second channel portion 21 is adjoined by a widening mouth 22, by means of which the channel diameter markedly increases toward the mouth.

The needle 19 has a length of approximately 20 mm, and the outlet channel 18 has a length of approximately 6 mm. The needle 19 therefore protrudes forward by 14 mm from the discharge tip 17. Depending on the embodiment, the diameter of the needle 19 can be between 0.5 mm and 1.8 mm. The needle 19 is made of a soft-annealed steel. The needle 19 can therefore be bent to the side without breaking or without the channel in the interior being closed.

When the needle 19 is in its final position in the outlet channel, a gap 16 between the outer wall of the needle 19 and the outlet channel 18 remains in the area of the widening mouth 22 and of the second channel portion 21. Using a suitable tool, an adhesive 24 is injected into the area of the widening mouth 22, such that the adhesive penetrates rearward along the gap 16. Adhesive 24 is introduced in such a quantity as to ensure that the gap 16 is filled completely with adhesive 24. It is possible for some of the adhesive 24 also to penetrate into the first channel portion 20. When the adhesive 24 has hardened and has formed a firm connection with the needle 19 and with the outlet channel 18, the needle 19 is securely fixed in the outlet channel 18.

In FIG. 4, view A on the left shows a discharge tip 17 in which the outlet channel 18 has a smaller diameter, and view B on the right shows a discharge tip 17 in which the outlet channel has a greater diameter. It is a considerable advantage that a single injection mold suffices to produce both of the embodiments according to FIG. 4A and FIG. 4B. For this purpose, another insert, which defines the dimension of the outlet channel 18, simply has to be fitted into the injection mold.

Alternatively, it is also possible to insert into the outlet channel 18 a needle 19 that has a smaller diameter than the outlet channel 18 along the entire length. The needle 19 is fixed only when the adhesive fills the gap and hardens. In this embodiment, the housing with the outlet channel 18 can be produced as a single injection-molded part and can be provided with needles 19 of different diameter depending on the intended use.

A further difference from the embodiment according to FIG. 3 is that, in the second channel portion 21, elongate depressions 25 are formed in the wall of the outlet channel 18. As a result of the depressions 25, the adhesive 24 has more space to force its way rearward in the gap 16.

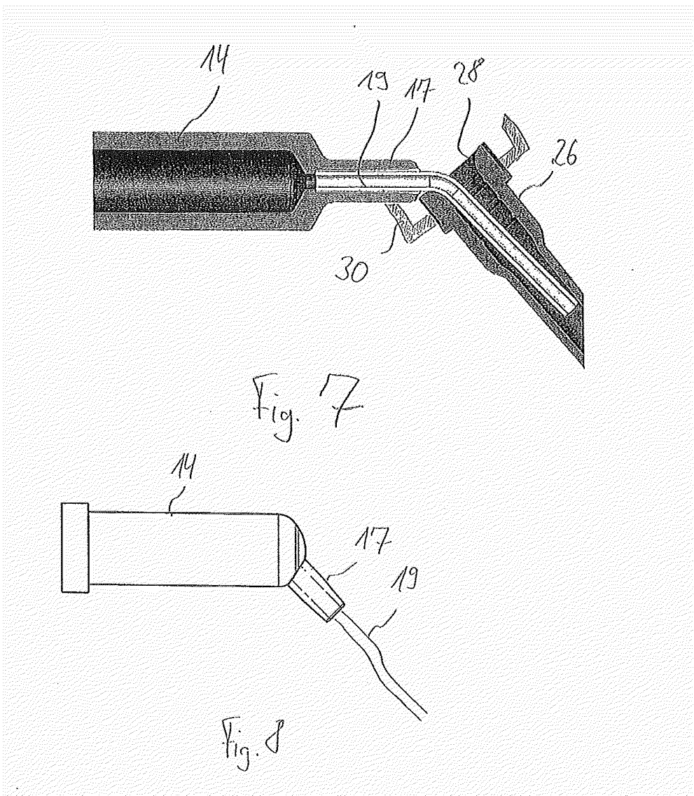

FIG. 5 shows a dispensing container in which a cap 26 is fitted onto the discharge tip 17. The cap 26 protects the dental compound from contact with the ambient air and protects the needle 19 from damage caused by impacts. To make fitting and removing the cap 26 easier, longitudinal ribs (not visible in the cross-sectional view in FIG. 6) are formed on the outer face of the cap 26. The needle 19 is closed at its front end and instead has outlet openings 31 facing to the side.

Peripheral webs 27 are formed on the inner wall of the cap 26 and are adapted to the circumference of the discharge tip 17. The webs 27 bear on the discharge tip 17, as a result of which the cap 26 is held in place and a seal is provided with respect to the environment.

At its rear end, the cap 26 is provided with an outwardly facing bulge 28. According to FIG. 7, the bulge 28 can be used as an abutment for bending the needle 19 with the aid of the cap 26. The cap 26 comprises a limit stop 30 at its rear end. The limit stop 30 abuts against the discharge tip 17 when the needle 19 is bent at the correct angle, about 30° in the example shown.

In the embodiment in FIG. 8, the discharge tip 17 extends at an angle of about 40° relative to the longitudinal axis of the housing 14. In this configuration, it is not necessary to bend the needle 19 before it can be inserted into the cavity of a molar. The needle 19 is made of elastic polypropylene, such that the needle 19, during insertion, can easily follow the course of the root canal.

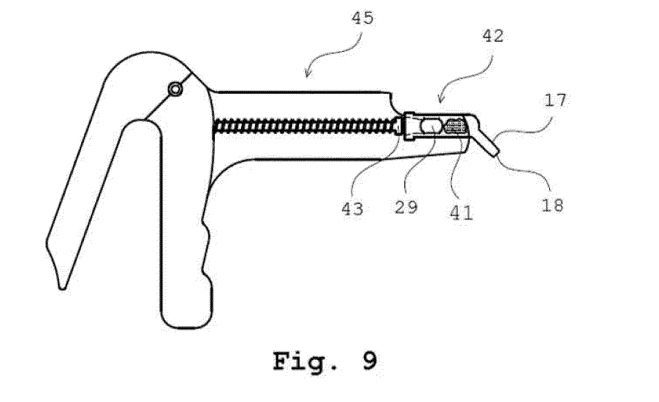

In the embodiment in FIG. 9, the discharge tool 45 contains dispensing container 42. Inside the dispensing container 42 there is a dental compound 41 and a plunger 29. The discharge tool 45 comprises a ram 43 for pressing the plunger 29 forward. The ram is operated by pushing the handle, which is shown in the left side of the figure. The ram 43 pushes against the back surface of the plunger 29, thereby pressing the dental compound 41 through outlet channel 18.

In the embodiment depicted in FIG. 9, the dispensing container 42 is a disposable part. Once the dispensing container 42 is used, it may be separated from the discharge tool 45. In order to use the discharge tool 45 once again, another dispensing container 42 with another amount of dental compound 41 is attached to the discharge tool 45. The plunger 29 is pushed against the ram 43 of the new dispensing container 42 for dispensing the dental compound. In the depicted embodiment, the plunger 29 and dental compound 41 are incorporated into a single, replaceable dispensing container 42. In alternate embodiments, the plunger 29 may be separate from the dispensing container 42 and may be replaced separately.

1. A dispensing system for dispensing a dental compound, comprising:
a dispensing container in the form of a compule, a plunger, and a discharge tool in the form of a compule gun;
the dispensing container comprises a housing, on an inside of which a slide surface is formed extending parallel to a central axis of the housing and configured for engagement with the plunger, the housing enclosing an interior and being provided with an outlet channel at a forward end, a portion of a needle being inserted into the outlet channel, and the housing with outlet channel being designed as a one-piece injection-molded part, wherein a gap is present between a circumference of the needle and the outlet channel, and wherein an adhesive is introduced into the gap;
the plunger being received inside the housing and cooperating with the slide surface of the housing; and
the discharge tool comprising a ram which applies pressure to a back surface of the plunger opposite said forward end.

2. The dispensing system of claim 1, wherein a limit stop for the needle is provided in the outlet channel.

3. The dispensing system of claim 1, wherein the outlet channel provides a lateral guide for the needle.

4. The dispensing system of claim 3, wherein the outlet channel comprises a first channel portion and a second channel portion, and wherein an inner surface of the outlet channel is adapted to the outer surface of the needle in the first channel portion.

5. The dispensing system of claim 1, wherein the outlet channel narrows in a direction of a rear end of the dispensing container.

6. The dispensing system of claim 1, wherein the outlet channel has a widening mouth.

7. The dispensing system of claim 1, wherein the needle is bendable.

8. The dispensing system of claim 1, wherein the housing comprises a discharge tip through which the outlet channel extends and a cap adapted to the discharge tip is with an inner wall of the cap has an outwardly directed bulge at a rear end.

9. The dispensing system of claim 8, wherein the cap is provided with a limit stop, and wherein the limit stop bears on the housing when the needle is bent through a predetermined angle.

10. The dispensing system as claimed in claim 8, wherein a peripheral web is formed on an inner wall of the cap.

11. The dispensing system of claim 1, wherein the outlet channel encloses an angle with a longitudinal axis of the housing, said angle being between 25° and 60°.

12. The dispensing system of claim 1, wherein the needle has an elastic flexibility.

13. The dispensing system of claim 1, wherein the outlet channel encloses an angle with the central axis of the housing, said angle being between 30° and 45°

14. The dispensing system of claim 2, wherein the outlet channel narrows in the direction of a rear end opposite said forward end.

15. The dispensing system of claim 3, wherein the outlet channel narrows in the direction of a rear end opposite said forward end.

16. The dispensing system of claim 4, wherein the outlet channel narrows in the direction of a rear end opposite said forward end.

17. The dispensing system of claim 2, wherein the outlet channel has a widening mouth.

18. The dispensing system of claim 3, wherein the outlet channel has a widening mouth.

19. The dispensing system of claim 1, wherein the dispensing container is a replaceable element.

20. The dispensing system of claim 1, wherein the dispensing container and the plunger are a unified replaceable element.
